(19) United States
(12) Patent Application Publication
(10) Pub. No.: US 2022/0056054 A1
(43) Pub. Date: Feb. 24, 2022

(54) METHODS OF PREPARATION OF AMINOBORANES AND APPLICATIONS FOR BORYLATION AND SUZUKI COUPLING

(71) Applicant: Purdue Research Foundation, West Lafayette, IN (US)

(72) Inventors: Padinjaremadhom V. Ramachandran, West Lafayette, IN (US); Henry J. Hamann, West Lafayette, IN (US)

(73) Assignee: Purdue Research Foundation, West Lafayette, IN (US)

(21) Appl. No.: 17/407,278

(22) Filed: Aug. 20, 2021

Related U.S. Application Data
(60) Provisional application No. 63/068,391, filed on Aug. 21, 2020.

(51) Int. Cl. C07F 5/02

(52) U.S. Cl. CPC C07F 5/027; C07F 5/025

(57) ABSTRACT

The present invention relates to a process for the preparation of aminoboranes (RR′N—BH₂), and aminoborane-amine complexes (RR′N—BH₂:NRR′R″), wherein R, and R′ of the aminoborane can be the same or different alkyl groups, and R, R′, and R″ of the amine complex can be the same or different alkyl groups or hydrogen. The dialkylaminoboranes have been utilized for the preparation of aryl and alkenylboronate esters via dehaloborylation of the corresponding aryl or alkenyl halides, followed by treatment with alcohols or diols. The process and the products thereof are within the scope of this disclosure.

### CROSS-REFERENCE TO RELATED APPLICATIONS

The present U.S. patent application relates to and claims the priority benefit of U.S. Provisional Patent Application Ser. No. 63/068,391, filed Aug. 21, 2020, the contents of which are hereby incorporated by reference in its entirety into this disclosure.

### TECHNICAL FIELD

The present invention generally relates to a process for the preparation of aminoboranes (RR′N—BH₂) and aminoborane-amine complexes (RR′N—BH₂:NRR′R″) wherein R, and R′ of the aminoborane can be the same or different alkyl groups and R, R′, and R″ of the amine complex can be the same or different alkyl groups or hydrogen. The dialkylaminoboranes have been utilized for the preparation of aryl and alkenylboronate esters via dehaloborylation of the corresponding aryl or alkenyl halides, followed by treatment with alcohols/diols.

### BACKGROUND AND SUMMARY OF THE INVENTION

This section introduces aspects that may help facilitate a better understanding of the disclosure. Accordingly, these statements are to be read in this light and are not to be understood as admissions about what is or is not prior art.

Boronic acids and esters are extremely important intermediates for several organic synthesis applications. They are particularly useful as partners in Suzuki-Miyaura coupling reactions.¹ There are several procedures available for their synthesis. The original synthesis of boronic acids and esters involved treating an organometals with a trialkylborate (Scheme 1).² Modern day preparations of boronic acids and esters involves a transition metal catalyzed borylation of aryl halides or triflates with dialkoxyborane³ or their dimers (Scheme 2). Several procedures for the direct dehaloborylations have also been reported (Scheme 3).⁴

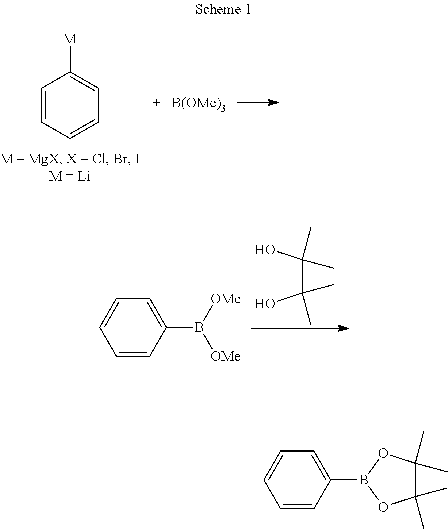

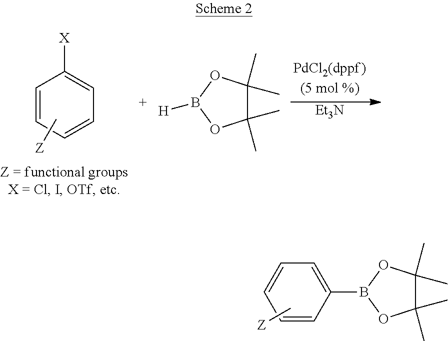

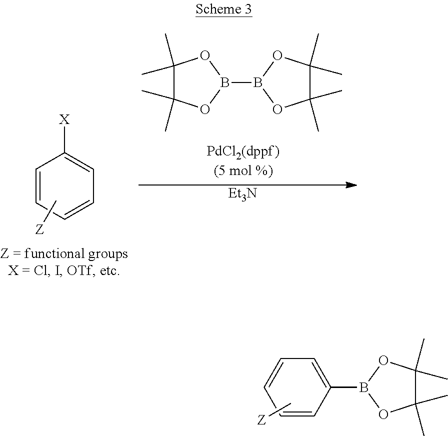

Monoalkyl-aminoboranes exist as a dimer and dialkylaminoboranes exist as a monomer or dimer, depending on the steric size of the alkyl group. Vaultier, Alcaraz and coworkers reported the preparation of dialkylaminoboranes, diisopropylaminoborane in particular, from the corresponding dialkylamine-borane via thermal elimination of hydrogen at 160° C. (Scheme 4).⁵ Further, they reported the utility of diisopropylaminoborane for the borylation of aryl halides. (Scheme 5). A major disadvantage of this protocol is the necessity to heat the amine-boranes at high temperatures (above 160° C.).

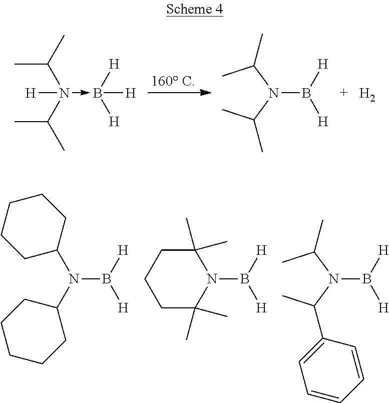

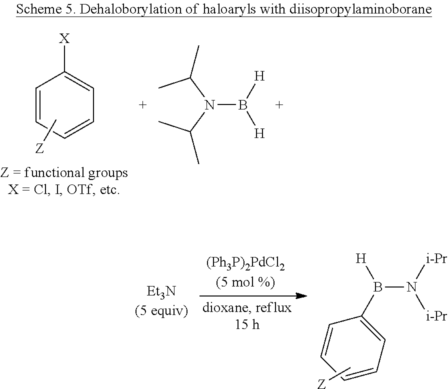

This was later circumvented by the synthesis of diisopropylaminoborane from the corresponding amine-boranes via the addition of ethereal hydrogen chloride, followed by removal of hydrogen chloride (Scheme 6).⁶ Again, the use of corrosive and expensive ethereal hydrogen chloride requires inert conditions. The use of an acid could be detrimental to several functional groups.

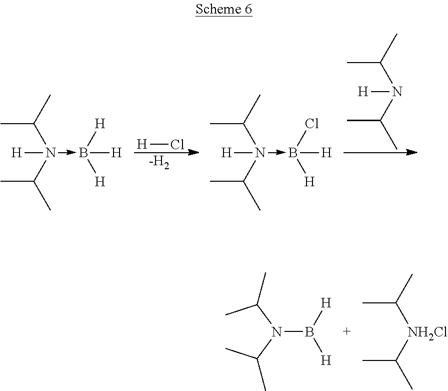

Singaram and coworkers reported the preparation of such aminoboranes from the corresponding lithium aminoborohydrides by treatment with methyl iodide, trimethylsilyl chloride, or benzyl chloride (Scheme 7).⁷ This procedure to prepare aminoboranes necessitates the preparation of lithium aminoborohydrides realized by the treatment of amine-boranes with costly and air- and moisture-sensitive butyllithium (Scheme 7). In addition, reagents such as methyl iodide and trimethylsilyl chloride are expensive. Benzyl chloride is a lachrymator and methyl iodide is known to depress the central nervous system (CNS), irritate the lungs and skin, and affect the kidneys. There are unmet needs for a safe and more efficient syntheses of aminoboranes.

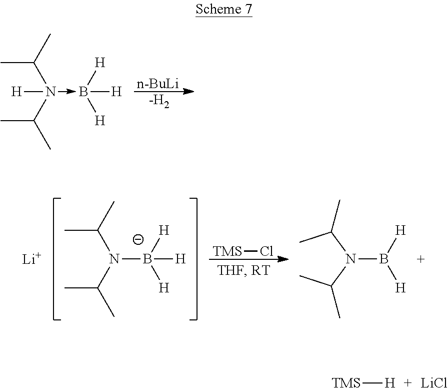

These and other features, aspects and advantages of the present invention will become better understood with reference to the following detailed description and claims.

### BRIEF DESCRIPTION OF DRAWINGS

FIG. 1 shows the structure of the monomers of dialkylaminoboranes synthesized using our new protocol

FIG. 2 depicts the ¹¹B NMR spectrum from the reaction of pyrrolidine-monoiodoborane with Hünigs base.

FIG. 3 shows the representative Suzuki coupling partners prepared from sodium borohydride (SBH).

### DETAILED DESCRIPTION

While the concepts of the present disclosure are illustrated and described in detail in the description herein, results in the description are to be considered as exemplary and not restrictive in character; it being understood that only the illustrative embodiments are shown and described and that all changes and modifications that come within the spirit of the disclosure are desired to be protected.

As used herein, the following terms and phrases shall have the meanings set forth below. Unless defined otherwise, all technical and scientific terms used herein have the same meaning as commonly understood to one of ordinary skill in the art.

In the present disclosure the term “about” can allow for a degree of variability in a value or range, for example, within 10%, within 5%, or within 1% of a stated value or of a stated limit of a range. In the present disclosure the term “substantially” can allow for a degree of variability in a value or range, for example, within 90%, within 95%, 99%, 99.5%, 99.9%, 99.99%, or at least about 99.999% or more of a stated value or of a stated limit of a range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The term “substituted” as used herein refers to a functional group in which one or more hydrogen atoms contained therein are replaced by one or more non-hydrogen atoms. The term “functional group” or “substituent” as used herein refers to a group that can be or is substituted onto a molecule. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, azides, hydroxylamines, cyano, nitro groups, N-oxides, hydrazides, and enamines; and other heteroatoms in various other groups.

The term “alkyl” as used herein refers to substituted or unsubstituted straight chain and branched alkyl groups and cycloalkyl groups having from 1 to about 20 carbon atoms (C₁-C₂₀), 1 to 12 carbons (C₁-C₁₂), 1 to 8 carbon atoms (C₁-C₈), or, in some embodiments, from 1 to 6 carbon atoms (C₁-C₆). Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to substituted or unsubstituted straight chain and branched divalent alkenyl and cycloalkenyl groups having from 2 to 20 carbon atoms (C₂-C₂₀), 2 to 12 carbons (C₂-C₁₂), 2 to 8 carbon atoms (C₂-C₈) or, in some embodiments, from 2 to 4 carbon atoms (C₂-C₄) and at least one carbon-carbon double bond. Examples of straight chain alkenyl groups include those with from 2 to 8 carbon atoms such as —CH═CH—, —CH═CHCH₂—, and the like. Examples of branched alkenyl groups include, but are not limited to, —CH═C(CH₃)— and the like.

An alkynyl group is the fragment, containing an open point of attachment on a carbon atom that would form if a hydrogen atom bonded to a triply bonded carbon is removed from the molecule of an alkyne. The term “hydroxyalkyl” as used herein refers to alkyl groups as defined herein substituted with at least one hydroxyl (—OH) group.

The term “cycloalkyl” as used herein refers to substituted or unsubstituted cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. In some embodiments, cycloalkyl groups can have 3 to 6 carbon atoms (C₃-C₆). Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like.

The term “acyl” as used herein refers to a group containing a carbonyl moiety wherein the group is bonded via the carbonyl carbon atom. The carbonyl carbon atom is also bonded to another carbon atom, which can be part of a substituted or unsubstituted alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-40, 6-10, 1-5 or 2-5 additional carbon atoms bonded to the carbonyl group. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to substituted or unsubstituted cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons (C₆-C₁₄) or from 6 to 10 carbon atoms (C₆-C₁₀) in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “aralkyl” and “arylalkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to substituted or unsubstituted aromatic and non-aromatic ring compounds containing 3 or more ring members, of which, one or more is a heteroatom such as, but not limited to, B, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. In some embodiments, heterocyclyl groups include heterocyclyl groups that include 3 to 8 carbon atoms (C₃-C₈), 3 to 6 carbon atoms (C₃-C₆) or 6 to 8 carbon atoms (C₆-C₈).

A heteroaryl ring is an embodiment of a heterocyclyl group. The phrase “heterocyclyl group” includes fused ring species including those that include fused aromatic and non-aromatic groups. Representative heterocyclyl groups include, but are not limited to pyrrolidinyl, azetidinyl, piperidinyl, piperazinyl, morpholinyl, chromanyl, indolinonyl, isoindolinonyl, furanyl, pyrrolidinyl, pyridinyl, pyrazinyl, pyrimidinyl, triazinyl, thiophenyl, tetrahydrofuranyl, pyrrolyl, oxazolyl, oxadiazolyl, imidazolyl, triazyolyl, tetrazolyl, benzoxazolinyl, benzthiazolinyl, and benzimidazolinyl groups.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclylalkyl groups include, but are not limited to, furan-2-yl methyl, furan-3-yl methyl, pyridine-3-yl methyl, tetrahydrofuran-2-yl methyl, and indol-2-yl propyl.

The term “heteroarylalkyl” as used herein refers to alkyl groups as defined herein in which a hydrogen or carbon bond of an alkyl group is replaced with a bond to a heteroaryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a mono alkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom. The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, —CF(CH₃)₂ and the like.

The term “optionally substituted,” or “optional substituents,” as used herein, means that the groups in question are either unsubstituted or substituted with one or more of the substituents specified. When the groups in question are substituted with more than one substituent, the substituents may be the same or different. When using the terms “independently,” “independently are,” and “independently selected from” mean that the groups in question may be the same or different. Certain of the herein defined terms may occur more than once in the structure, and upon such occurrence each term shall be defined independently of the other.

The compounds described herein may contain one or more chiral centers or may otherwise be capable of existing as multiple stereoisomers. It is to be understood that in one embodiment, the invention described herein is not limited to any particular stereochemical requirement, and that the compounds, and compositions, methods, uses, and medicaments that include them may be optically pure, or may be any of a variety of stereoisomeric mixtures, including racemic and other mixtures of enantiomers, other mixtures of diastereomers, and the like. It is also to be understood that such mixtures of stereoisomers may include a single stereochemical configuration at one or more chiral centers, while including mixtures of stereochemical configuration at one or more other chiral centers.

Similarly, the compounds described herein may include geometric centers, such as cis, trans, E, and Z double bonds. It is to be understood that in another embodiment, the invention described herein is not limited to any particular geometric isomer requirement, and that the compounds, and compositions, methods, uses, and medicaments that include them may be pure, or may be any of a variety of geometric isomer mixtures. It is also to be understood that such mixtures of geometric isomers may include a single configuration at one or more double bonds, while including mixtures of geometry at one or more other double bonds.

As used herein, the term “salts” and “pharmaceutically acceptable salts” refer to derivatives of the disclosed compounds wherein the parent compound is modified by making acid or base salts thereof. Examples of pharmaceutically acceptable salts include, but are not limited to, mineral or organic acid salts of basic groups such as amines; and alkali or organic salts of acidic groups such as carboxylic acids. Pharmaceutically acceptable salts include the conventional non-toxic salts or the quaternary ammonium salts of the parent compound formed, for example, from non-toxic inorganic or organic acids. For example, such conventional non-toxic salts include those derived from inorganic acids such as hydrochloric, hydrobromic, sulfuric, sulfamic, phosphoric, and nitric; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, toluenesulfonic, methanesulfonic, ethane disulfonic, oxalic, and isethionic, and the like.

Pharmaceutically acceptable salts can be synthesized from the parent compound which contains a basic or acidic moiety by conventional chemical methods. In some instances, such salts can be prepared by reacting the free acid or base forms of these compounds with a stoichiometric amount of the appropriate base or acid in water or in an organic solvent, or in a mixture of the two; generally, nonaqueous media like ether, ethyl acetate, ethanol, isopropanol, or acetonitrile are preferred. Lists of suitable salts are found in Remington's Pharmaceutical Sciences, 17th ed., Mack Publishing Company, Easton, Pa., 1985, the disclosure of which is hereby incorporated by reference.

The present invention relates to a process for the preparation of aminoboranes (RR′N—BH₂), wherein R, and R′ can be the same or different alkyl groups. The dialkylaminoboranes have been utilized for the preparation of aryl and alkenylboronate esters via dehaloborylation of the corresponding aryl or alkenyl halides, followed by treatment with alcohols/diols.

In some illustrative embodiments, the present disclosure relates to a process for manufacturing a dialkylaminoborane comprising the steps of
a. preparing an amine-borane;
b. adding iodine to said amine-borane to afford a reaction mixture containing amine-monoiodoborane; and
c. adding a bulky dialkylamine or trialkylamine to the reaction mixture of iodine and amine-borane and working up to afford said dialkylaminoborane.

In some illustrative embodiments, the present disclosure relates to a process for manufacturing a dialkylaminoborane as disclosed herein, wherein said process further comprises a step of reacting said dialkyaminoborane with an aryl halide, an aryl triflate, an aryl tosylate, or an aryl mesylate in the presence of a palladium catalyst to afford an aryl(dialkylamino)borane.

In some illustrative embodiments, the present disclosure relates to a process for manufacturing a dialkylaminoborane as disclosed herein, wherein said process further comprises a step of reacting said aryl(dialkylamino) borane with an aliphatic or an aromatic diol to afford an aryl boronate.

In some illustrative embodiments, the present disclosure relates to a process for manufacturing a dialkylaminoborane as disclosed herein, wherein said aliphatic diol is pinacol and said aromatic diol is catechol.

In some illustrative embodiments, the present disclosure relates to a process for manufacturing a dialkylaminoborane as disclosed herein, wherein said amine-borane is diisopropylamine-borane, dicyclohexylamine-borane, dibenzylamine-borane, or 2,6-dimethylpiperidine-borane.

In some illustrative embodiments, the present disclosure relates to a process for manufacturing a dialkylaminoborane as disclosed herein, wherein said process comprises an intermediate of a primary amine-monoiodoborane complex (RNH₂—BH₂I) or a secondary amine-monoiodoborane complex (R₂NH—BH₂I).

In some illustrative embodiments, the present disclosure relates to a process for manufacturing a dialkylaminoborane as disclosed herein, wherein said dialkylamine is diisopropylamine, dibenzylamine, dicyclohexylamine, or diisobutylamine.

In some illustrative embodiments, the present disclosure relates to a process for manufacturing a dialkylaminoborane as disclosed herein, wherein said trialkylamine is N,N-diisopropylethylamine.

In some illustrative embodiments, the present disclosure relates to a product manufactured according to the manufacturing process of a dialkylaminoborane as disclosed herein.

In some illustrative embodiments, the present disclosure relates to a process for manufacturing an alkylaminoborane-amine complex comprising the steps of:
a. preparing an amine-borane;
b. adding iodine to said amine-borane to afford a reaction mixture; and
c. adding ammonia or an alkyl, dialkyl, trialkylamine, or heteroaromatic amine to the reaction mixture of iodine and amine-borane and working up to afford said alkylaminoborane-amine complex.

In some illustrative embodiments, the present disclosure relates to a process for manufacturing an alkylaminoborane-amine complex as disclosed herein, wherein said process further comprises a step of reacting said alkyaminoborane-amine complex with an aryl halide, an aryl triflate, an aryl tosylate, or an aryl mesylate in the presence of a palladium catalyst to afford an aryl(alkylamino)borane.

In some illustrative embodiments, the present disclosure relates to a process for manufacturing an alkylaminoborane-amine complex as disclosed herein, wherein said process further comprises a step of reacting said aryl(alkylamino)borane with aliphatic or aromatic diols to afford an aryl boronate.

In some illustrative embodiments, the present disclosure relates to a process for manufacturing an alkylaminoborane-amine complex as disclosed herein, wherein said aliphatic diol is pinacol and said aromatic diol is catechol.

In some illustrative embodiments, the present disclosure relates to a process for manufacturing an alkylaminoborane-amine complex as disclosed herein, wherein said process comprises an intermediate of a primary amine-monoiodoborane complex (RNH₂—BH₂I) or a secondary amine-monoiodoborane complex (R₂NH—BH₂I).

In some illustrative embodiments, the present disclosure relates to a process for manufacturing an alkylaminoborane-amine complex as disclosed herein, wherein said alkylamine is propylamine, t-butylamine, or benzylamine.

In some illustrative embodiments, the present disclosure relates to a process for manufacturing an alkylaminoborane-amine complex as disclosed herein, wherein said dialkylamine is diethylamine, piperidine, azepane, or morpholine.

In some illustrative embodiments, the present disclosure relates to a process for manufacturing an alkylaminoborane-amine complex as disclosed herein, wherein said trialkylamine is triethylamine or N,N-diisopropylethylamine.

In some illustrative embodiments, the present disclosure relates to a process for manufacturing an alkylaminoborane-amine complex as disclosed herein, wherein said heteroaromatic amine is pyridine.

In some illustrative embodiments, the present disclosure relates to a product manufactured according to the manufacturing process of an alkylaminoborane-amine complex as disclosed herein.

In some other illustrative embodiments, the present disclosure relates to a process for preparing a dialkylaminoborane via an dialkylamine borane intermediate comprising the steps of
a. preparing a dialkylamine hydrochloride and sodium borohydride;
b. mixing said dialkylamine hydrochloride and sodium borohydride in tetrahydrofuran (THF) to afford a reaction mixture;
c. stirring said reaction mixture at room temperature for a period of time to afford said dialkylamine borane intermediate;
d. removing the THF solvent and replacing with dichloromethane (DCM); and
e. adding a solution of I₂ in DCM to above reaction mixture followed by a solution of Hünig's base in DCM to afford said dialkylaminoborane.

In some other illustrative embodiments, the present disclosure relates to a process for preparing a dialkylaminoborane via an dialkylamine borane intermediate as disclosed herein, wherein said process further comprises a step of reacting said dialkyaminoborane with an aryl halide, an aryl triflate, an aryl tosylate, or an aryl mesylate in the presence of a palladium catalyst to afford an aryl(dialkylamino)borane.

In some other illustrative embodiments, the present disclosure relates to a process for preparing a dialkylaminoborane via an dialkylamine borane intermediate as disclosed herein, wherein said process further comprises a step of reacting said aryl(dialkylamino)borane with aliphatic or aromatic diols to afford an aryl boronate.

In some other illustrative embodiments, the present disclosure relates to a process for preparing a dialkylaminoborane via an dialkylamine borane intermediate as disclosed herein, wherein said aliphatic diol is pinacol and said aromatic diol is catechol.

In some other illustrative embodiments, the present disclosure relates to a process for preparing a dialkylaminoborane via an dialkylamine borane intermediate as disclosed herein, wherein said process comprises an intermediate of a primary amine-monoiodoborane complex (RNH₂—BH₂I) or a secondary amine-monoiodoborane complex (R₂NH—BH₂I).

In some other illustrative embodiments, the present disclosure relates to a one-pot process for preparation of an aryl boronate from sodium borohydride comprising the steps of
a. preparing dialkylamine hydrochloride and sodium borohydride;
b. dissolving said dialkylamine hydrochloride and sodium borohydride in THF to afford a reaction mixture;
c. stirring said reaction mixture at room temperature for about two hours, then removing the THF solvent and replacing with toluene;
d. adding about 0.5 equivalent of I₂ dissolved in toluene with stirring;
e. adding about 5 equivalents of diisopropylamine to the reaction mixture at room temperature under stirring for about five minutes;
f. adding about 5% of PdCl₂(dppp) together with an aryl halide to the reaction mixture and refluxing for about 16 h; and
g. then adding a pinacol at room temperature to the reaction mixture and stirring the reaction mixture for a period of time about 4 h to afford said aryl boronate. Novel Synthesis of Dialkylaminoboranes

A new synthetic protocol for the preparation of alkylaminoboranes has been discovered. Preparation of aminoboranes by treating amine-boranes with iodine in reagent grade solvents at room temperature, followed by treatment with an amine for dehydroiodination provides the aminoboranes (Scheme 8).

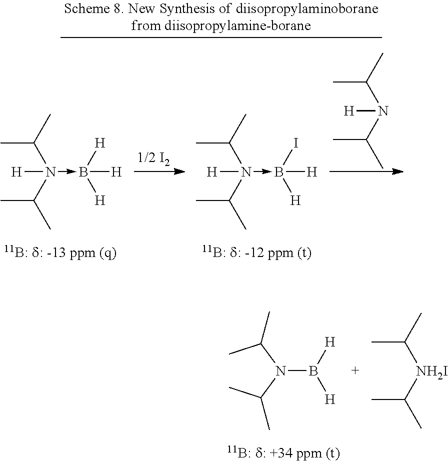

While investigating methods of activating amine-boranes, it was noted that bromine and iodine would readily dehydrogenate amine-borane complexes, introducing one or more halogens onto boron. Distinct from previous approaches to aminoborane synthesis, we envisioned the addition of molecular halogens to amine-borane complexes. It was thought that the dehydrohalogenation of an intermediate amine-monohaloboranes would readily produce the corresponding aminoboranes, as had been shown for the monochloroborane derivatives, while avoiding the pitfalls of other methodologies. At the onset of our studies, dimethylamine-borane (DMAB) was selected as a model compound. Based on the proposed method of aminoborane formation, it is ideal for the amine to be secondary, and dimethylamine-borane is a highly crystalline, bench-stable reagent, readily prepared via the metathesis reaction of its hydrochloride salt with sodium borohydride.⁸ Optimization of the amine-borane halogenation was carried out by subjecting dimethylamine-borane to 0.5 and 1.0 equivalents of either bromine or iodine in a range of aprotic solvents (Scheme 9).

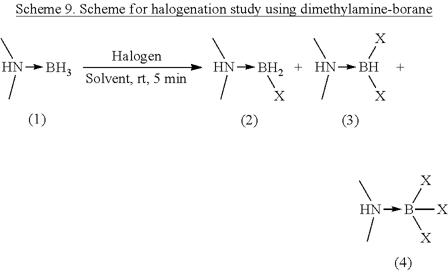

The reactions of dimethylamine-borane (Scheme 9 (1)) with bromine tended to provide the di- (Scheme 9 (3)) and trihalogenated (Scheme 9 (4)) borane products, the desired amine-monohaloborane (Scheme 9 (2)) could be reliably produced in either dichloromethane (DCM) or toluene (PhMe) using 0.5 equivalents of iodine (Table 1, entries 1 and 7). The full details of the optimization are seen in Table 1, with the ¹¹B NMR peak ratios corresponding to dimethylamine-borane (1), the monohaloborane (2), dihaloborane (3), and trihaloborane (4), which are seen in Scheme 9. These variously halogenated species were easily detected using ¹¹B NMR spectroscopy, with the triplet, doublet and singlet peaks corresponding to the mono-, di-, and trihaloborane dimethylamine complexes.

TABLE 1
Optimization details for halogenation of dimethylamine-borane

| | | | | | | ¹¹B NMR |
|---|---|---|---|---|---|---|
| | | Halogen | Amine- | Amine- | | Peak ratio |
| Entry | Halogen | Eq. | borane | borane Eq. | Solvent | (1:2:3:4) |
| 1 | I₂ | 0.5 | DMAB | 1.0 | DCM | 0:1:0:0 |
| 2 | I₂ | 1.0 | DMAB | 1.0 | DCM | 0:4:1:0 |
| 3 | Br₂ | 0.5 | DMAB | 1.0 | DCM | 1.25:1:3:0 |
| 4 | Br₂ | 1.0 | DMAB | 1.0 | DCM | 0:1:1:0.75 |
| 5 | I₂ | 0.5 | DMAB | 1.0 | CHCl₃ | Indeterminate |
| 6 | I₂ | 0.5 | DMAB | 1.0 | Et₂O | Indeterminate |
| 7 | I₂ | 0.5 | DMAB | 1.0 | PhMe | 0:1:0:0 |
| 8 | I₂ | 0.5 | DMAB | 1.0 | Pentane | AB Insoluble |

To demonstrate the wider applicability of this halogenation procedure, a series of amine-boranes was produced. The generated borane complexes were then subjected to the optimized halogenation conditions as shown in Scheme 10.

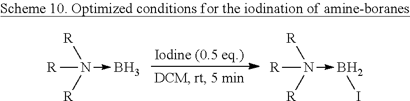

The results of those reactions showed, that not only were secondary amine-boranes amenable to the iodination process, but that primary and tertiary amine-boranes, as well as the secondary phosphine-borane, also underwent facile halogenation after 5 minutes at room temperature. Each of the primary (Table 2, entries 1 and 2), secondary amine-boranes (Table 2, entries 3-17), and tertiary amine-boranes (Table 2, entry 19) were converted quantitatively to their corresponding amine-monoiodoborane complexes, as determined by ¹¹B NMR spectroscopic analysis. The phosphine-borane tested, however, underwent only 94% conversion (Table 2, entry 18), with the lost conversion being accounted for by the presence of unreacted diphenylphosphine-borane.

After it had been determined that the monoiodoborane-amine complexes were readily formed using the optimized conditions, the next and final step towards aminoborane formation would be the dehydrohalogention. This was shown to be readily accomplished for the earlier described monochloroborane-amine by the addition of a sufficiently bulky amine to the reaction mixture containing the amine-haloborane complex.

TABLE 2
Summary of results for the iodination of amine- and phosphine-boranes

| | | | ¹¹B NMR |
|---|---|---|---|
| Entry | Amine-borane | Amine-monoiodoborane # | Yield |
| 1 | Ethylamine-borane | Ethylamine-iodoborane | ≥99% |
| 2 | Isopropylamine-borane | Isopropylamine-iodoborane | ≥99% |
| 3 | Dimethylamine-borane | Dimethylamine-iodoborane | ≥99% |
| 4 | Diethylamine-borane | Diethylamine-iodoborane | ≥99% |
| 5 | Dipropylamine-borane | Dipropylamine-iodoborane | ≥99% |
| 6 | Diisopropylamine-borane | Diisopropylamine-iodoborane | ≥99% |
| 7 | Dibutylamine-boran | Dibutylamine-iodoboran | ≥99% |
| 8 | Diisobutylamine-borane | Diisobutylamine-iodoborane | ≥99% |
| 9 | Dipentylamine-borane | Dipentylamine-iodoborane | ≥99% |
| 10 | Dicyclohexylamine-borane | Dicyclohexylamine-iodoborane | ≥99% |
| 11 | Piperidine-borane | Piperidine-iodoborane | ≥99% |
| 12 | 2,6-Dimethylpiperidine-borane | 2,6-Dimethylpiperidine-iodoborane | ≥99% |
| 13 | 2,2,6,6-Tetramethylpiperidine-borane | 2,2,6,6-Tetramethylpiperidine-iodoborane | ≥99% |
| 14 | Morpholine-borane | Morpholine-iodoborane | ≥99% |
| 15 | Azepane-borane | Azepane-iodoborane | ≥99% |
| 16 | Pyrrolidine-borane | Pyrrolidine-iodoborane | ≥99% |
| 17 | Dibenzylamine-borane | Dibenzylamine-iodoborane | ≥99% |
| 18 | Diphenylphosphine-borane | Diphenylphosphine-iodoborane | 94% |
| 19 | Triethylamine-borane | Triethylamine-iodoborane | ≥99% |

It was observed that the choice of amine is important for the formation of the aminoborane. Vaultier's report recommends the use of the same amine as in the amine-borane for the dehydrohalogenation since a different amine can result in the formation of amine-exchange products. However, we observed that utilization of a bulky amine, such as Hünig's base or diisopropylamine, for the dehydroiodination yields dialkylaminoboranes in higher monomer ratio (Scheme 11).

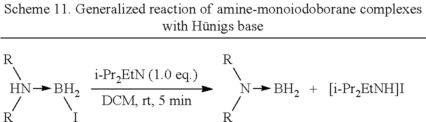

The results of each of the dehydrohalogenation reactions would be analyzed using ¹¹B NMR spectroscopy. From the spectra obtained, the ratio of the aminoborane monomer and aminoborane dimer, as well as the sum of any other detected species, could be determined. The dehydrohalogenation reaction was performed on each of the amine-monoiodoboranes reported in Table 2, with the exception of diphenylphosphine-monoiodoborane, as that iodination reaction did not go to completion. A summary of the amine-monoiodoboranes subjected to the dehydrohalogenation conditions, along with the relative percentages (as determined by ¹¹B NMR) of aminoborane monomer, aminoborane dimer, and other species, is reported in Table 3.

TABLE 3
Product ratios from dehydrohalogenation of amine-iodoboranes

| | | Amine | Dimer | Monomer | Other |
|---|---|---|---|---|---|
| Entry | Monoiodoborane Complex | Used | (%) | (%) | (%) |
| 1 | Ethylamine-iodoborane | i-Pr₂EtN | 14 | 11 | 76 |
| 2 | Isopropylamine-iodoborane | i-Pr₂EtN | 0 | 0 | ≥99 |
| 3 | Dimethylamine-iodoborane | i-Pr₂EtN | 58 | 22 | 20 |
| 4 | Diethylamine-iodoborane | i-Pr₂EtN | 5 | 77 | 18 |
| 5 | Dipropylamine-iodoborane | i-Pr₂EtN | 0 | 78 | 22 |
| 6 | Diisopropylamine-iodoborane | i-Pr₂EtN | 0 | ≥99 | 0 |
| 7 | Dibutylamine-iodoborane | i-Pr₂EtN | 0 | 80 | 20 |
| 8 | Diisobutylamine-iodoborane | i-Pr₂EtN | 0 | 97 | 3 |
| 9 | Dipentylamine-iodoborane | i-Pr₂EtN | 0 | 86 | 14 |
| 10 | Dicyclohexylamine-iodoborane | i-Pr₂EtN | 0 | ≥99 | 0 |
| 11 | Piperidine-iodoborane | i-Pr₂EtN | 70 | 23 | 7 |
| 12 | 2,6-Dimethylpiperidine-iodoborane | i-Pr₂EtN | 0 | ≥99 | 0 |
| 13 | 2,2,6,6-Tetramethylpiperidine-iodoborane | i-Pr₂EtN | 0 | 21 | 79 |
| 14 | Morpholine-iodoborane | i-Pr₂EtN | 36 | 7 | 58 |
| 15 | Azepane-iodoborane | i-Pr₂EtN | 30 | 59 | 11 |
| 16 | Pyrrolidine-iodoborane | i-Pr₂EtN | 37 | 5 | 58 |
| 17 | Dibenzylamine-iodoborane | i-Pr₂EtN | 0 | ≥99 | 0 |
| 18 | Triethylamine-iodoborane | i-Pr₂EtN | 0 | 0 | ≥99 |

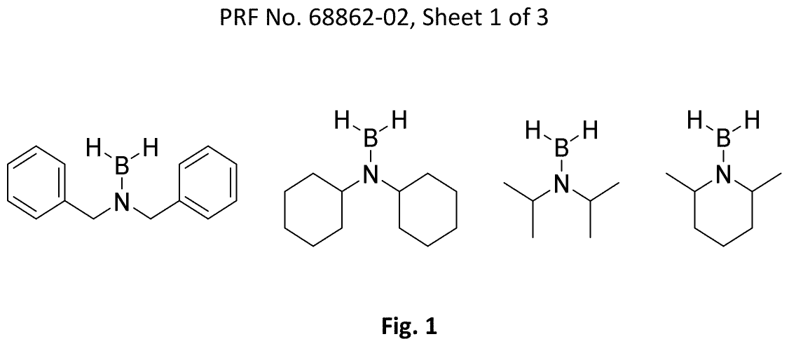

As can be seen in Table 3, the reaction of Hünigs base with each of the amine-iodoborane complexes provided, in most cases, at least some of the aminoborane monomer product, though the ratios varied. The dehydrohalogenation of iodoborane complexes with primary amines yielded very little of either the monomeric or dimeric aminoborane, but primarily a complex mixture of other boron species. The monoiodoboranes complexes with secondary amines provided mainly aminoborane products, in either monomeric or dimeric form, with the ratio dependent on the sterics of the amine. Several amine-monoiodoborane complexes were converted entirely to the corresponding aminoborane monomers. Diisopropylaminoborane, dicyclohexylaminoborane, 2,6-dimethylpiperidinoborane, and dibenzylaminoborane were each detected (by ¹¹B NMR) as only the monomeric products. These exclusively monomeric product ratios are shown in Table 3 (Entries 6, 10, 12, and 17). The structures of different pure monomers of dialkylaminoboranes prepared utilizing our new protocol are presented in FIG. 1.

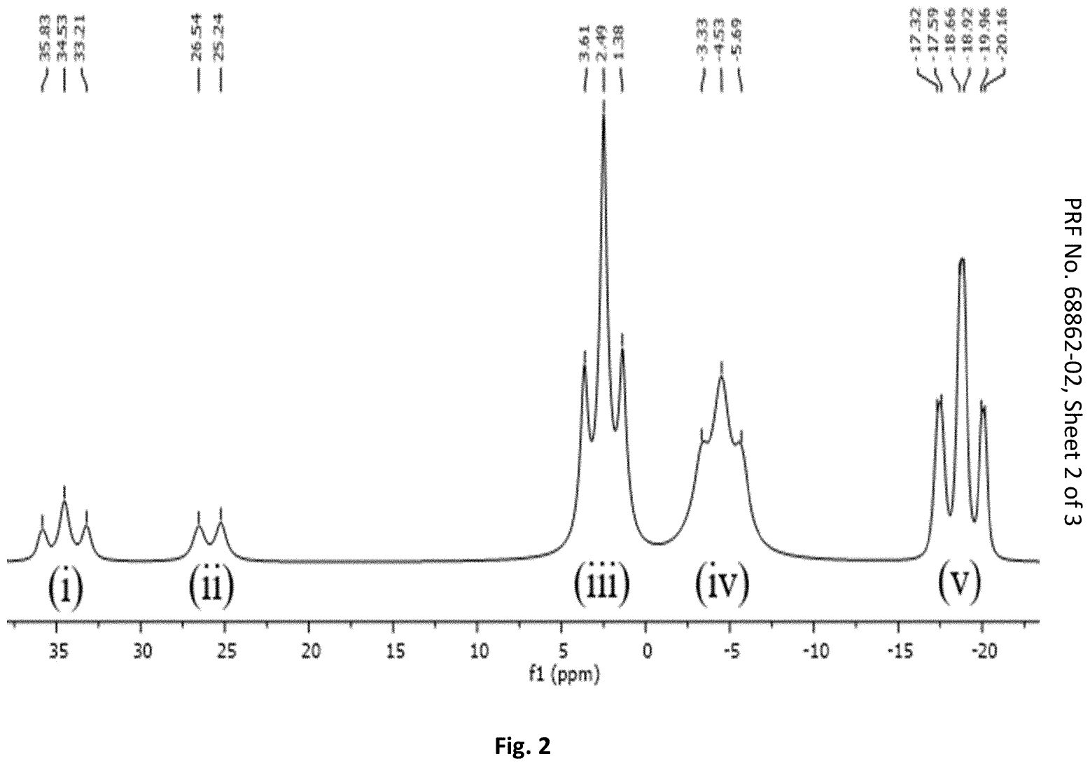

The aminoborane monomer was the intended product of the dehydroiodination reaction, shown in Scheme 11, however, several distinct chemical species could be identified in many of the reaction mixtures. The reaction of pyrrolidine-monoiodoborane with N-ethyldiisopropylamine (Hünigs base) provided a reaction mixture whose ¹¹B NMR spectrum showed each of the products of the dehydrohalogenation reaction. The ¹¹B NMR spectrum obtained is shown in FIG. 2 with the baseline removed.

Five distinct species were produced in the reaction of pyrrolidine-monoiodoborane with Hünigs base, labeled i-v in FIG. 2. Species i and iii, located at δ 34.52 ppm and δ 2.49 ppm respectively, were identified as the monomer (i) and dimer (iii) of the desired aminoborane products. Upon further analysis, the potential identities of the remaining species were subsequently proposed to be the diaminoborane (ii), aminoborane-amine complex (iv), and aminodiborane (v). A summary of the chemical shifts and splitting for the peaks, as well as the tentatively proposed identities and structures of the species observed is given in Table 4.

TABLE 4
Compounds resulting from the reaction of pyrrolidine-iodoborane with
Hünigs base

| En- | Species | ¹¹B NMR | | Species |
|---|---|---|---|---|
| try | (FIG. 2) | Values | Proposed Structure | Identity |
| 1 | i | δ 34.52 (t) | 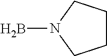 | Aminoborane monomer |
| 2 | ii | δ 25.89 (d) | 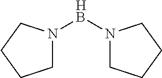 | Diamino- borane |
| 3 | iii | δ 2.49 (t) | 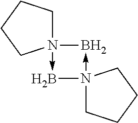 | Aminoborane dimer |
| 4 | iv | δ −4.52 (t) | 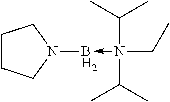 | Amino- borane- amine complex |
| 5 | v | δ −18.77 (td) | 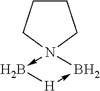 | Amino- diborane |

Although the aminoborane monomer was the intended product, the aminoborane-amine complex was identified as a potentially useful intermediate. This species is comprised of an aminoborane monomer with an additional equivalent of the added amine coordinated to the boron of the aminoborane monomer. The coordination of a second amine to the boron of the monomer unit could act to stabilize the monomer, much like the dimerization of monomers provides an increase in stability. To further test the steric requirements for aminoborane monomer formation, dimer formation, and the formation of the aminoborane-amine complex, a second series of dehydrohalogenation reaction were performed to accompany the series described in Table 3. The earlier series had been performed by first preparing the monoiodoborane, verifying its formation by ¹¹B NMR, and then completing the dehydrohalogenation by adding Hünigs base. This second series would proceed directly to the addition of the amine, without confirmation of the intermediate monoiodoborane. This was deemed reasonable as the formation of the monoiodoborane had been validated many times. The tandem halogenation-dehydrohalogenation reaction would additionally be performed using a small series of amine-boranes while varying the amine added to the reaction mixture. Whereas the earlier series had been performed only utilizing Hünigs base as the added amine. The amine-boranes selected for testing were diisopropylamine-borane, dimethylamine-borane, piperidine-borane, benzylamine-borane, and t-butylamine-borane. The most substantial testing was done using diisopropylamine-borane, as it had already been shown to readily form the corresponding aminoborane monomer. A more precise understanding of the results provided by the steric environment of the added amine was of particular interest. The results of this study are summarized in Table 5.

The results of the dehydrohalogenation reactions utilizing different amines were in close accordance with the early series performed using only N-ethyldiisopropylamine. The reactions using diisopropylamine-borane as the starting amine-borane produced none of the corresponding aminoborane dimer, no matter what amine was added to the reaction. The aminoborane monomer resulting from diisopropylamine-borane was produced only if the added amine was sufficiently bulky, with even triethylamine only providing 80% of the monomer. The added amines which allowed for monomer formation of at least 98% were diisopropylamine, dicyclohexylamine, diisobutylamine, and N-ethyldiisopropylamine, while dibenzylamine allowed 90% monomer formation. The remainder of the amines tested with the monoiodoborane complex formed from diisopropylamine-borane gave mainly the corresponding aminoborane-amine complexes, denoted as ‘Other’ in Table 5.

TABLE 5
Summary of amine sterics for the dehydrohalogenation reaction

| | | | | Monomer | Other |
|---|---|---|---|---|---|
| Entry | Amine-borane | Added Amine | Dimer (%) | (%) | (%) |
| 1 | Diisopropylamine-BH₃ | Diisopropylamine | 0 | ≥99 | 0 |
| 2 | Diisopropylamine-BH₃ | Diethylamine | 0 | 0 | ≥99 |
| 3 | Diisopropylamine-BH₃ | Propylamine | 0 | 0 | ≥99 |
| 4 | Diisopropylamine-BH₃ | t-Butylamine | 0 | 0 | ≥99 |
| 5 | Diisopropylamine-BH₃ | Benzylamine | 0 | 0 | ≥99 |
| 6 | Diisopropylamine-BH₃ | Dibenzylamine | 0 | 90 | 10 |
| 7 | Diisopropylamine-BH₃ | Dicyclohexylamine | 0 | ≥99 | 0 |
| 8 | Diisopropylamine-BH₃ | Diisobutylamine | 0 | 98 | 2 |
| 9 | Diisopropylamine-BH₃ | Azepane | 0 | 0 | ≥99 |
| 10 | Diisopropylamine-BH₃ | Piperidine | 0 | 0 | ≥99 |
| 11 | Diisopropylamine-BH₃ | Morpholine | 0 | 0 | ≥99 |
| 12 | Diisopropylamine-BH₃ | Ammonia | 0 | 0 | ≥99 |
| 13 | Diisopropylamine-BH₃ | Triethylamine | 0 | 80 | 20 |
| 14 | Diisopropylamine-BH₃ | N-Ethyldiisopropylamine | 0 | ≥99 | 0 |
| 15 | Diisopropylamine-BH₃ | Pyridine | 0 | 0 | ≥99 |
| 16 | Dimethylamine-BH₃ | Piperidine | 0 | 0 | ≥99 |
| 17 | Dimethylamine-BH₃ | Triethylamine | 40 | 1 | 59 |
| 18 | Dimethylamine-BH₃ | N-Ethyldiisopropylamine | 77 | 7 | 16 |
| 19 | Piperidine-BH₃ | Piperidine | 0 | 0 | ≥99 |
| 20 | Piperidine-BH₃ | N-Ethyldiisopropylamine | 89 | 2 | 9 |
| 21 | Benzylamine-BH₃ | Piperidine | 0 | 0 | ≥99 |
| 22 | Benzylamine-BH₃ | N-Ethyldiisopropylamine | 0 | 0 | ≥99 |
| 23 | t-Butylamine-BH₃ | Piperidine | 0 | 0 | ≥99 |
| 24 | t-Butylamine-BH₃ | N-Ethyldiisopropylamine | 0 | 0 | ≥99 |

The monoiodoborane complexes from secondary amine-boranes gave primarily the dimeric product in the reactions with highly bulky N-ethyldiisopropylamine, 77% for dimethylamine-borane and 89% for piperidine-borane. Whereas dimethylamine-borane and piperidine-borane gave mainly aminoborane-amine complexes when using less bulky piperidine as the added amine. None of the reactions utilizing primary amine-boranes (benzylamine-borane and t-butylamine-borane) gave either the monomeric or dimeric aminoborane products, yielding the aminoborane-amine complexes exclusively in all reactions.

The aminoborane-amine complexes are composed of the aminoborane formed from the complexation of the added amine to the aminoborane monomer formed from the starting amine-borane (Scheme 12). Realizing the potential utility of these materials, the aminoborane-amine complexes formed from the reactions summarized in Table 5 are listed in Table 6, with the corresponding ¹¹B NMR shift values determined for the complexes. In Table 6, the R₁ and R₂ groups are from the starting amine-borane, and R₃, R₄, and R₅ groups come from the added amine.

TABLE 6
Scheme 12
Aminoborane-amine complexes with ¹¹B NMR shifts

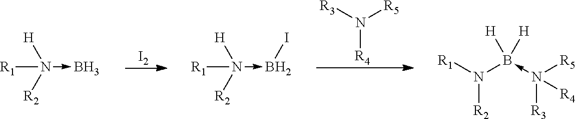

| | Amine-Borane | | Added Amine | | | ¹¹B NMR |
|---|---|---|---|---|---|---|
| Entry | R₁ | R₂ | R₃ | R₄ | R₅ | Shift |
| 1 | i-Pr | i-Pr | Et | Et | H | δ −4.39 |
| 2 | i-Pr | i-Pr | Pr | H | H | δ −9.70 |
| 3 | i-Pr | i-Pr | t-Bu | H | H | δ −13.79 |
| 4 | i-Pr | i-Pr | Bn | H | H | δ −9.65 |
| 5 | i-Pr | i-Pr | Azepane | | H | δ −2.42 |
| 6 | i-Pr | i-Pr | Piperidine | | H | δ −1.78 |
| 7 | i-Pr | i-Pr | Morpholine | | H | δ −1.81 |
| 8 | i-Pr | i-Pr | H | H | H | δ −14.25 |
| 9 | i-Pr | i-Pr | | Pyridine | | δ −4.47 |
| 10 | Me | Me | Piperidine | | H | δ −1.85 |
| 11 | Me | Me | Et | Et | Et | δ −2.94 |
| 12 | Me | Me | | Pyridine | | δ −0.72 |
| 13 | Piperidine | | Piperidine | | H | δ −1.84 |
| 14 | Piperidine | | | Pyridine | | δ −1.19 |
| 15 | Bn | H | Piperidine | | H | δ −1.84 |
| 16 | Bn | H | Et | Et | Et | δ −7.43 |
| 17 | Bn | H | i-Pr | i-Pr | Et | δ −6.13 |
| 18 | Bn | H | | Pyridine | | δ −3.90 |
| 19 | t-Bu | H | Piperidine | | H | δ −1.84 |
| 20 | t-Bu | H | | Pyridine | | δ −5.92 |

While the aminoborane-amine complexes described above have not yet been utilized, recent literature has described several uses for dialkylaminoboranes, particularly diisopropylaminoborane. We believe that the most important application is the dehaloborylation of aryl halides or triflates to the corresponding arylaminoboranes (Scheme 5).

With a reliable method for the formation of monomeric aminoborane now in hand, its application to the borylation of aryl halides was examined. Initially, the reactions conditions optimized and reported by Pucheault and coworkers,⁹ were utilized. The borylation protocol employed generates the aminoborane in one flask, and the aminoborane is then transferred in to a second flask containing the palladium catalyst, aryl halide substrate, and additional amine. After heating the combined mixture in toluene, an aminoarylborane intermediate is formed, which is quenched with methanol, forming the dimethyl boronate ester. The final product is formed after transesterification with pinacol. However, it was soon realized that the entire reaction could be performed in one flask without any filtration, as the byproduct of the aminoborane formation was the same as the byproduct of the borylation. The aminoborane would be generated, followed by the addition of the remaining reagents to the same flask. Using these modified conditions, a 95% yield of boronate ester was obtained. We have now shown that the dialkylaminoboranes prepared using our new procedure also can be used for dehaloboration of aryl halides (Scheme 13).

Both the Vaultier and Singaram reports mentioned above utilized a Lewis-base exchange protocol to prepare the amine-boranes necessary for the preparation of the corresponding aminoboranes. We prepared the amine-boranes directly from sodium borohydride (SBH) utilizing one of our reported procedures, involving sodium borohydride and amines in the presence of sodium bicarbonate and water (Scheme 14).¹⁰

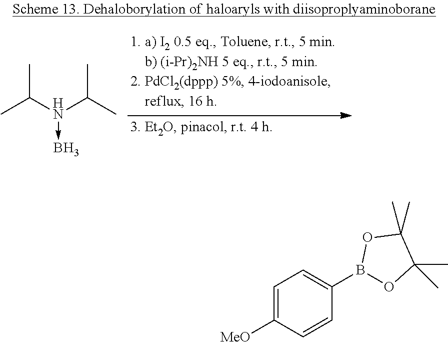

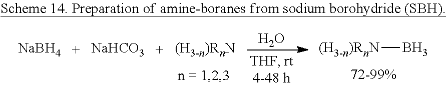

Synthesis of Dialkylaminoboranes from Sodium Borohydride

We have also discovered a novel synthesis of dialkylaminoboranes, eg. diisopropylaminoborane starting from sodium borohydride. For this, the dialkylamine borane was prepared via a salt metathesis reaction (treating SBH with amine hydrochlorides), followed by reaction with iodine and Hünig's base (Scheme 15).

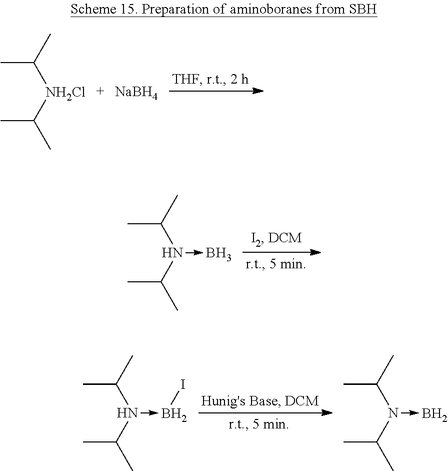

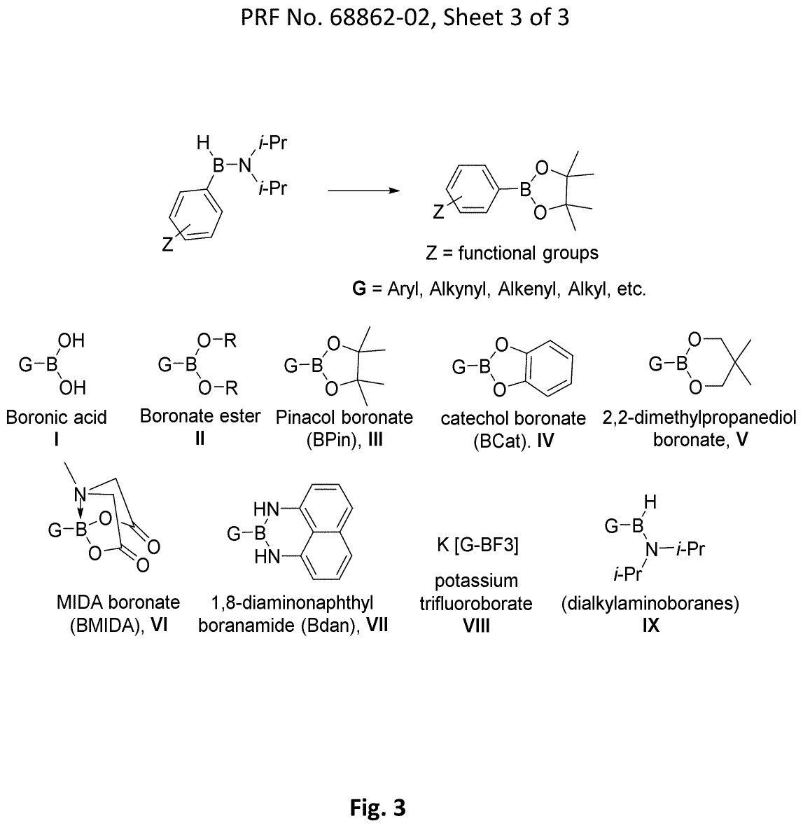

Vaultier has reported the conversion of the aminoarylborane to other boronate derivatives or potassium aryltrifluoroborate salts that are routinely used for Suzuki coupling reaction. Our new synthesis of aminoboranes provides a facile and economical route to the preparation of arylaminoboranes and other Suzuki coupling arylboron partners without difficulty, starting with sodium borohydride. We have demonstrated the preparation of a representative example of the boron derivatives (I-IX) (FIG. 3).

Synthesis of Aryl Boronates from Sodium Borohydride

Our new synthesis of aminoboranes from SBH provided an opportunity to prepare alkenyl or aryl boronate esters directly from sodium borohydride, which has been demonstrated in this disclosure (Scheme 16).

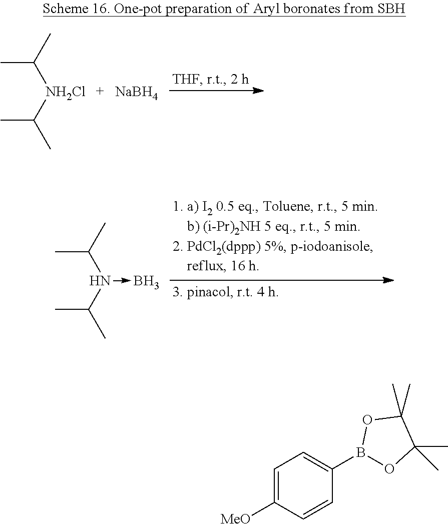

Representative Experimental Procedures

Preparation of Monoiodoborane-Amines from Amine-Boranes

In an oven dried 25 mL round bottom flask containing a stir bar was weighed diisopropylamine borane (1 eq, 1 mmol, 0.115 g). Dichloromethane (5 mL, 0.2 M) was added to dissolve the amine borane. Then, with vigorous stirring, iodine (0.5 eq, 0.5 mmol, 0.1269 g) was added portion wise to limit frothing. The reaction mixture was stirred for 5 minutes. An aliquot of the mixture was removed and used to check the ¹¹BNMR at this point to ensure formation of the monoiodoborane. The monoiodoborane can be isolated by evaporation of the dichloromethane, yielding an air and moisture sensitive solid, or used as is in solution.

Preparation of Aminoboranes from Amine-Boranes

In an oven dried 25 mL round bottom flask containing a stir bar was weighed diisopropylamine borane (1 eq, 1 mmol, 0.115 g). Dichloromethane (5 mL, 0.2 M) was added to dissolve the amine borane. Then, with vigorous stirring, iodine (0.5 eq, 0.5 mmol, 0.1269 g) was added portion wise to limit frothing. The reaction mixture was stirred for 5 minutes. An aliquot of the mixture was removed and used to check the ¹¹BNMR at this point to ensure formation of the monoiodoborane. The aliquot was added back to the reaction mixture and again with vigorous stirring, diisopropylamine (2 eq, 2 mmol, 0.29 mL) was added in a single portion. The diisopropylamino borane was formed immediately, and was verified by ¹¹BNMR, which showed a nearly quantitative conversion as indicated by the single peak at δ 34.46 (t, J=126.8 Hz). Diisopropylamino borane should be used promptly after formation to prevent any degradation.

Preparation of Aminoborane-Amine Complexes from Amine-Boranes

In an oven dried 25 mL round bottom flask containing a stir bar was weighed dimethylamine borane (1 eq, 1 mmol, 0.059 g). Dichloromethane (5 mL, 0.2 M) was added to dissolve the amine borane. Then, with vigorous stirring, iodine (0.5 eq, 0.5 mmol, 0.1269 g) was added portion wise to limit frothing. The reaction mixture was stirred for 5 minutes. An aliquot of the mixture was removed and used to check the ¹¹BNMR at this point to ensure formation of the monoiodoborane. The aliquot was added back to the reaction mixture and again with vigorous stirring, piperidine (2 eq, 2 mmol, 0.20 mL) was added in a single portion. The dimethylaminoborane was formed immediately, and was verified by ¹¹BNMR, which showed a nearly quantitative conversion as indicated by the single peak at 6-1.85 (t, 114.1 Hz). The dimethylamino-borane piperidine complex can be extracted from the reaction mixture by addition of 10 mL of dichloromethane, followed by washing with water (3×5 mL) and brine (1×5 mL). The organic layer is then dried over sodium sulfate, filtered and condensed.

Preparation of Aryl(Dialkylamino)Boranes from Amine-Boranes

In an oven dried 25 mL two-necked round bottom flask, the amine-borane complex (1.5 eq., 3.0 mmol, 0.345 g) was weighed. Toluene (5 mL) is added to the flask at room temperature, then iodine (0.75 eq., 1.5 mmol, 0.380 g) was added portion wise to avoid boil over. After stirring for 5 min at room temperature, diisopropylamine (4.0 eq., 8.0 mmol, 1.12 mL) was added and the solution was stirred for 5 minutes. Into the flask was then added 4-iodoanisole (1.0 eq., 2.0 mmol, 0.4681 g), followed by PdCl₂dppp (0.05 eq., 0.1 mmol, 24 mg). The reaction mixture was heated at 110° C. for 16 h before being cooled to 0° C. The aryl(dialkylamino)borane can be used as is in solution for the preparation of aryl boronates. It can also be isolated as an air and moisture sensitive oil by filtration under inert conditions through oven-dried celite. The celite is washed with anhydrous diethyl ether, and all volatiles evaporated under vacuum.

Preparation of Aryl Boronates from Amine-Boranes

In an oven dried 25 mL two-necked round bottom flask, the amine-borane complex (1.5 eq., 3.0 mmol, 0.345 g) was weighed. Toluene (5 mL) is added to the flask at room temperature, then iodine (0.75 eq., 1.5 mmol, 0.380 g) was added portion wise to avoid boil over. After stirring for 5 min at room temperature, diisopropylamine (4.0 eq., 8.0 mmol, 1.12 mL) was added and the solution was stirred for 5 minutes. Into the flask was then added 4-iodoanisole (1.0 eq., 2.0 mmol, 0.4681 g), followed by PdCl₂dppp (0.05 eq., 0.1 mmol, 24 mg). The reaction mixture was heated at 110° C. for 16 h before being cooled to 0° C., quenched with anhydrous methanol (2 mL) and stirred for 1 h at room temperature. All volatiles were removed under vacuum before adding diethyl ether (2 mL) and pinacol (1.3 eq., 2.6 mmol, 0.307 g). The mixture was stirred for 4 h at room temperature. Then the reaction mixture was diluted with diethyl ether (10 mL), and the organic phase was washed first with a solution of HCl (0.1 N, 2×10 mL), it was then dried over Na₂SO₄, filtered and concentrated under vacuum. The crude oil was passed through a pad of silica gel, eluting with diethyl ether. The resulting filtrate was concentrated under vacuum and eventually purified by flash chromatography if any impurities were still present in the product. The product is obtained as a clear, light yellow oil (95%, 445 mg).

Preparation of Amine-Monoiodoboranes from Sodium Borohydride

In an oven dried 50 mL round bottom flask containing a stir bar was weighed diisopropylammonium hydrochloride (1.5 eq., 1.5 mmol, 206 mg), and sodium borohydride (1.5 eq., 1.5 mmol, 57 mg). Tetrahydrofuran (3 mL) was added to the flask, and the reaction mixture was stirred at room temperature for 2 hours. An aliquot of the mixture was removed and used to check the ¹¹BNMR at this point to ensure formation of the amine-borane. The aliquot was added back to the reaction mixture and the reaction mixture was filtered through a cotton plugged cannula into an oven dried 25 mL round bottom flask. The residue left behind in the original flask was washed with an additional portion of tetrahydrofuran (3 mL) which was also transferred via the cannula to the 25 mL flask. All volatiles were evaporated under vacuum yielded diisopropylamine-borane (75%, 1 mmol, 0.115 g). Then dichloromethane (5 mL, 0.2 M) was added to dissolve the amine borane. Then, with vigorous stirring, iodine (0.5 eq, 0.5 mmol, 0.1269 g) was added portion wise to limit frothing. The reaction mixture was stirred for 5 minutes. An aliquot of the mixture was removed and used to check the ¹¹BNMR at this point to ensure formation of the monoiodoborane. The monoiodoborane can be isolated by evaporation of the dichloromethane, yielding an air and moisture sensitive solid, or used as it is in solution.

Preparation of Aminoboranes from Sodium Borohydride

In an oven dried 50 mL round bottom flask containing a stir bar was weighed diisopropylammonium hydrochloride (1.5 eq., 1.5 mmol, 206 mg), and sodium borohydride (1.5 eq., 1.5 mmol, 57 mg). Tetrahydrofuran (3 mL) was added to the flask, and the reaction mixture was stirred at room temperature for 2 hours. An aliquot of the mixture was removed and used to check the ¹¹BNMR at this point to ensure formation of the amine-borane. The aliquot was added back to the reaction mixture and the reaction mixture was filtered through a cotton plugged cannula into an oven dried 25 mL round bottom flask. The residue left behind in the original flask was washed with an additional portion of tetrahydrofuran (3 mL) which was also transferred via the cannula to the 25 mL flask. All volitiles were evaporated under vacuum yielded diisopropylamine-borane (75%, 1 mmol, 0.115 g). Then dichloromethane (5 mL, 0.2 M) was added to dissolve the amine borane. Then, with vigorous stirring, iodine (0.5 eq, 0.5 mmol, 0.1269 g) was added portion wise to limit frothing. The reaction mixture was stirred for 5 minutes. An aliquot of the mixture was removed and used to check the ¹¹BNMR at this point to ensure formation of the monoiodoborane. The aliquot was added back to the reaction mixture and again with vigorous stirring, diisopropylamine (2 eq, 2 mmol, 0.29 mL) was added in a single portion. The diisopropylamino borane was formed immediately, and was verified by ¹¹BNMR, which showed a nearly quantitative yield as indicated by the single peak at δ 34.46 (t, J=126.8 Hz). The diisopropylamino borane should be used promptly after formation to prevent any degradation.

Preparation of Aryl(Dialkylamino)Boranes from Sodium Borohydride

In an oven dried 50 mL round bottom flask containing a stir bar was weighed diisopropylammonium hydrochloride (4.5 eq., 4.5 mmol, 618 mg), and sodium borohydride (4.5 eq., 4.5 mmol, 171 mg). Tetrahydrofuran (10 mL) was added to the flask, and the reaction mixture was stirred at room temperature for 2 hours. An aliquot of the mixture was removed and used to check the ¹¹BNMR at this point to ensure formation of the amine-borane. The aliquot was added back to the reaction mixture and the reaction mixture was filtered through a cotton plugged cannula into an oven dried 50 mL two-necked round bottom flask. The residue left behind in the original flask was washed with an additional portion of tetrahydrofuran (10 mL) which was also transferred via the cannula to the 50 mL flask. All volatiles were evaporated under vacuum yielded diisopropylamine-borane (75%, 3 mmol, 0345 g). Toluene (5 mL) was then added to the flask at room temperature, followed by iodine (0.75 eq., 1.5 mmol, 0.380 g), added portion wise to avoid boil over. After stirring for 5 min at room temperature, diisopropylamine (4.0 eq., 8.0 mmol, 1.12 mL) was added and the solution was stirred for 5 minutes. Into the flask was then added 4-iodoanisole (1.0 eq., 2.0 mmol, 0.4681 g), followed by PdCl₂dppp (0.05 eq., 0.1 mmol, 24 mg). The reaction mixture was heated at 110° C. for 16 h before being cooled to 0° C. The aryl(dialkylamino)borane can be used as is in solution for the preparation of aryl boronates. It can also be isolated as an air and moisture sensitive oil by filtration under inert conditions through oven-dried celite. The celite is washed with anhydrous diethyl ether, and all volatiles evaporated under vacuum.

Preparation of Aryl Boronates from Sodium Borohydride

In an oven dried 50 mL round bottom flask containing a stir bar was weighed diisopropylammonium hydrochloride (4.5 eq., 4.5 mmol, 618 mg), and sodium borohydride (4.5 eq., 4.5 mmol, 171 mg). Tetrahydrofuran (10 mL) was added to the flask, and the reaction mixture was stirred at room temperature for 2 hours. An aliquot of the mixture was removed and used to check the ¹¹BNMR at this point to ensure formation of the amine-borane. The aliquot was added back to the reaction mixture and the reaction mixture was filtered through a cotton plugged cannula into an oven dried 50 mL two-necked round bottom flask. The residue left behind in the original flask was washed with an additional portion of tetrahydrofuran (10 mL) which was also transferred via the cannula to the 50 mL flask. All volatiles were evaporated under vacuum yielded diisopropylamine-borane (75%, 3 mmol, 0345 g). Toluene (5 mL) was then added to the flask at room temperature, followed by iodine (0.75 eq., 1.5 mmol, 0.380 g), added portion wise to avoid boil over. After stirring for 5 min at room temperature, diisopropylamine (4.0 eq., 8.0 mmol, 1.12 mL) was added and the solution was stirred for 5 minutes. Into the flask was then added 4-iodoanisole (1.0 eq., 2.0 mmol, 0.4681 g), followed by PdCl₂dppp (0.05 eq., 0.1 mmol, 24 mg). The reaction mixture was heated at 110° C. for 16 h before being cooled to 0° C., quenched with anhydrous methanol (2 mL) and stirred for 1 h at room temperature. All volatiles were removed under vacuum before adding diethyl ether (2 mL) and pinacol (1.3 eq., 2.6 mmol, 0.307 g). The mixture was stirred for 4 h at room temperature. Then the reaction mixture was diluted with diethyl ether (10 mL), and the organic phase was washed first with a solution of HCl (0.1 N, 2×10 mL), it was then dried over Na₂SO₄, filtered and concentrated under vacuum. The crude oil was passed through a pad of silica gel, eluting with diethyl ether. The resulting filtrate was concentrated under vacuum and eventually purified by flash chromatography if any impurities were still present in the product. The product is obtained as a clear, light yellow oil (95%, 445 mg).

Those skilled in the art will recognize that numerous modifications can be made to the specific implementations described above. The implementations should not be limited to the particular limitations described. Other implementations may be possible.

It is intended that that the scope of the present methods and compositions be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

### REFERENCES CITED

(1) Miyaura, N.; Suzuki, A. Chem Rev. 1995, 95, 2457.
(2) Brown, H. C.; Srebnik, M.; Cole, T. E. Organometallics 1986, 5, 2300.
(3) J. Org. Chem. 2000, 65, 1164-1168.
(4) Ishiyama, T.; Murata, M.; and Miyaura, N. J. Org. Chem. 1995, 60, 7508.
(5) a) Euzenat et. al. Chem. Commun. 2003, 2280; b) M. Vaultier, G. Alcaraz, C. Duriez, L. Euzenat, Y. Ribourdouille, WO Patent WO03053981
(6) Guerrand et. al. Adv. Synth. Catal. 2015, 357, 1167.
(7) a) D. Haddenham, C. L. Bailey, et al., Tetrahedron, 2011, 67, 576-583; b) L. Pasumansky, D. Haddenham, et al., J. Org. Chem. 2008, 73, 1898.
(8) Noth, H.; Beyer, H., Chem. Ber. Recl. 1960, 93, 928-938.
(9) Guerrand, H. D. S.; et al., Adv. Synth. Catal. 2015, 357, 1167-1174.
(10) a) Ramachandran, P. V.; Kulkarni, A. S.; Zhao, Y.; Mei, J. Chem. Comm. 2016, 52, 11885-11888; b) P. V. Ramachandran, A. S. Kulkarni, U.S. Pat. No. 9,988,402.

1. A process for manufacturing a dialkylaminoborane comprising the steps of
a. preparing an amine-borane;
b. adding iodine to said amine-borane to afford a reaction mixture containing amine-monoiodoborane; and
c. adding a bulky dialkylamine or trialkylamine to the reaction mixture of iodine and amine-borane and working up to afford said dialkylaminoborane.

2. The process of claim 1 further comprising a step of reacting said dialkyaminoborane with an aryl halide, an aryl triflate, an aryl tosylate, or an aryl mesylate in the presence of a palladium catalyst to afford an aryl(dialkylamino)borane.

3. The process of claim 2 further comprising a step of reacting said aryl(dialkylamino) borane with an aliphatic or aromatic diol to afford an aryl boronate.

4. The process according to claim 3, wherein said aliphatic diol is pinacol and said aromatic diol is catechol.

5. The process according to claim 1, wherein said amine-borane is diisopropylamine-borane, dicyclohexylamine-borane, dibenzylamine-borane, or 2,6-dimethylpiperidine-borane.

6. The process according to claim 1, wherein said process comprises an intermediate of a primary amine-monoiodoborane complex (RNH₂—BH₂I) or a secondary amine-monoiodoborane complex (R₂NH—BH₂I).

7. The process according to claim 1, wherein said dialkylamine is diisopropylamine, dibenzylamine, dicyclohexylamine, or diisobutylamine.

8. The process according to claim 1, wherein said trialkylamine is N,N-diisopropylethylamine.

9. A product manufactured according to the process of claim 1.

10. A process for manufacturing an alkylaminoborane-amine complex comprising the steps of:
a. preparing an amine-borane;
b. adding iodine to said amine-borane to afford a reaction mixture; and
c. adding ammonia or an alkyl, dialkyl, trialkylamine, or heteroaromatic amine to the reaction mixture of iodine and amine-borane and working up to afford said alkylaminoborane-amine complex.

11. The process of claim 10 further comprising a step of reacting said alkyaminoborane-amine complex with an aryl halide, an aryl triflate, an aryl tosylate, or an aryl mesylate in the presence of a palladium catalyst to afford an aryl(alkylamino)borane.

12. The process of claim 11 further comprising a step of reacting said aryl(alkylamino)borane with aliphatic or aromatic diols to afford an aryl boronate.

13. The process according to claim 12, wherein said aliphatic diol is pinacol and said aromatic diol is catechol.

14. The process according to claim 10, wherein said process comprises an intermediate of a primary amine-monoiodoborane complex (RNH₂—BH₂I) or a secondary amine-monoiodoborane complex (R₂NH—BH₂I).

15. The process according to claim 10, wherein said alkylamine is propylamine, tert-butylamine, or benzylamine.

16. The process according to claim 10, wherein said dialkylamine is diethylamine, piperidine, azepane, or morpholine.

17. The process according to claim 10, wherein said trialkylamine is triethylamine or N,N-diisopropylethylamine.

18. The process according to claim 10, wherein said heteroaromatic amine is pyridine.

19. A product manufactured according to the process of claim 10.

20. A process for preparing a dialkylaminoborane via an dialkylamine borane intermediate comprising the steps of
a. preparing a dialkyamine hydrochloride and sodium borohydride;
b. mixing said dialkyamine hydrochloride and sodium borohydride in tetrahydrofuran (THF) to afford a reaction mixture;
c. stirring said reaction mixture at room temperature for a period of time to afford said dialkylamine borane intermediate;
d. removing the THF solvent and replacing with dichloromethane (DCM); and
e. adding a solution of I₂ in DCM to above reaction mixture followed by a solution of Hünig's base in DCM to afford said dialkylaminoborane.

21. The process of claim 20 further comprising a step of reacting said dialkyaminoborane with an aryl halide, an aryl triflate, an aryl tosylate, or an aryl mesylate in the presence of a palladium catalyst to afford an aryl(dialkylamino)borane.

22. The process of claim 21 further comprising a step of reacting said aryl(dialkylamino)borane with aliphatic or aromatic diols to afford an aryl boronate.

23. The process according to claim 22, wherein said aliphatic diol is pinacol and said aromatic diol is catechol.

24. The process according to claim 20, wherein said process comprises an intermediate of a primary amine-monoiodoborane complex (RNH₂—BH₂I) or a secondary amine-monoiodoborane complex (R₂NH—BH₂I).

25. A one-pot process for preparation of an aryl boronate from sodium borohydride comprising the steps of
a. preparing dialkylamine hydrochloride and sodium borohydride;
b. dissolving said dialkylamine hydrochloride and sodium borohydride in THF to afford a reaction mixture;
c. stirring said reaction mixture at room temperature for about two hours, then removing the THF solvent and replacing with toluene;
d. adding about 0.5 equivalent of I₂ dissolved in toluene with stirring;
e. adding about 5 equivalents of diisopropylamine to the reaction mixture at room temperature under stirring for about five minutes;
f. adding about 5% of PdCl₂(dppp) together with an aryl halide to the reaction mixture and refluxing for about 16 h; and
g. then adding a pinacol at room temperature to the reaction mixture and stirring the reaction mixture for a period of time about 4 h to afford said aryl boronate.
